(19) United States
(12) Patent Application Publication
(10) Pub. No.: US 2006/0250605 A1
(43) Pub. Date: Nov. 9, 2006

(54) Compact-thin contact image sensor

(75) Inventors: Jyh-Long Chern, Hsinchu (TW); Ching-Shan Dai, Taoyuan City (TW); Jung-Chun Wu, Fengyuan City (TW); Jyh-Der Hwang, Hsinchu City (TW)

Correspondence Address: TROXELL LAW OFFICE PLLC, SUITE 1404, 5205 LEESBURG PIKE, FALLS CHURCH, VA, 22041, US

(73) Assignee: Chuan Liang Industrial Co., Ltd.

(21) Appl. No.: 11/120,971

(22) Filed: May 4, 2005

(51) Int. Cl. G06K 9/74

(52) U.S. Cl. 356/71

(57) ABSTRACT

The present invention provides a kind of compact-thin contact image sensor, particularly a fingerprint optical input apparatus, which can extract fingerprint image with a strip-type sensor. And it can produce fingerprint image with high definition, and shorten its size with the multibend light pipe. In addition, it has an enough guiding length for forming a strip area distributed uniformly, and the light would project on the strip-type fingerprint pressed on a transparent panel from some angle and reflect to the strip-type sensors by total internal reflection. Lastly, the forest fingerprint image would be extracted by moving the finger.

### BACKGROUND OF THE INVENTION

1) Field of the Invention

The present invention relates to a compact-thin contact image sensor, particularly a compact-and-thin fingerprint optical input apparatus. It can extract fingerprint image with a strip-type image sensor.

2) Description of the Prior Art

With the increasingly development of the modern science and technology, many electronic products have been developed gradually. Later, for convenient carrying, more and more small electronic products are published. However, for their small volume, users may miss them carelessly. Therefore, the safety of these small electronic products would be weakened.

To overcome the problem of the personal data loss for the loss of the small electronic products, some authentication development tools applied to electronic products are invented according to the fact that everyone has unparalleled and inimitable fingerprint.

There is a fingerprint optical input apparatus ever being invented and disclosed in U.S. Pat. No. 6,259,108 B1. It would place the fingerprint on a transparent platen, and scan it with an image sensor under the emission of a light source. And then extract the fingerprint image with a Graduated Refractive Index (GRIN) strip lens and project it to a linear image sensor for imaging. So that good identification effect can be obtained. In addition, the U.S. Pat. No. 6,538,243 brought forward several methods to improve the lighting, however it cannot be realized effectively in the compact and thin system.

In view of the foregoing problem, the prevent invention provides a kind of compact thin contact image sensor, which can overcome the defect.

### SUMMARY OF THE INVENTION

Recently, for mini products' the important status in our surroundings and increasingly growth, the present invention mainly provides a compact-thin contact image sensor, comprising a strip-size fingerpring contact interface on which the ray produced by a light source comprising a light pipe, and one or more surface-mounted light emitting diode (SM-LED) would irradiate, and a strip column lens that can obtain the Graduated Refractive Index (GRIN) to form a fingerprint image and shape on the strip-type sensor. And the strip-size image would be integrated and processed to be a perfect one by the software.

The compact-thin contact image sensor in accordance with the present invention comprises a strip-size fingerprint image apparatus having a multibend light pipe, so that it is applied to the mobile telephone, mobile mini disk, scanner, mouse, personal digital assistant or automobile key etc. electronic products.

### BRIEF DESCRIPTION OF THE DRAWINGS

FIG. 1 is the three-dimentional disassembly diagram of the present invention.

FIG. 2 is three-dimentional exploded view of the present invention.

FIG. 3 is the assembly cutway view of the present invention (for illustrating that the first ray guiding interface of the light pipe makes the total internal inflection with the fingerprint contact interface by means of folding surface).

FIG. 3-A is the sketch map of the partial present invention (located at the first ray guiding interface).

FIG. 3-B is the sketch map of the partial present invention (located at the first ray guiding interface).

FIG. 4 is the assembly cutaway view of the present invention (for illustrating that the first ray guiding interface of another light pipe makes the total internal inflection with the fingerprint contact interface by means of folding surface).

FIG. 5 is the assembly cutway view of the present invention (for illustrating that the first ray guiding interface of the light pipe makes the total internal inflection with the fingerprint contact interface by means of curving surface).

FIG. 6 is the assembly cutway view of the present invention (for illustrating that the first ray guiding interface of another light pipe makes the total internal inflection with the fingerprint contact interface by means of curving surface).

### DETAILED DESCRIPTION OF THE PREFERRED EMBODIMENTS

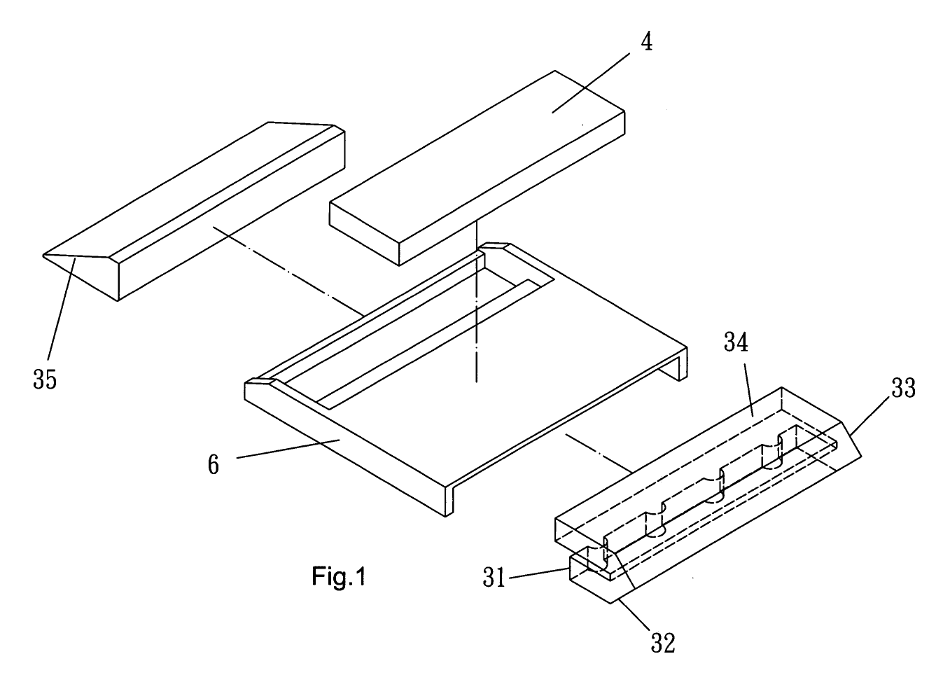

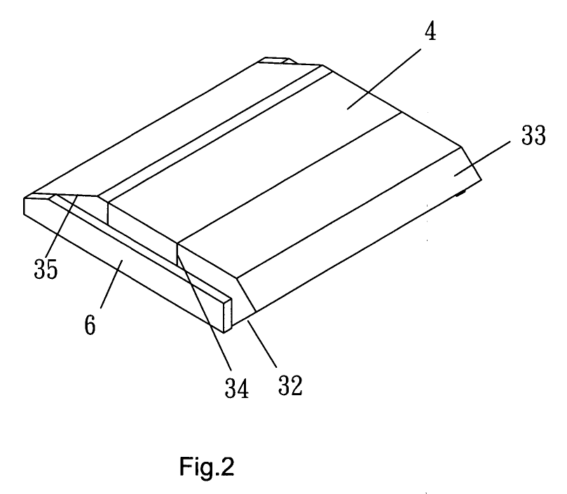

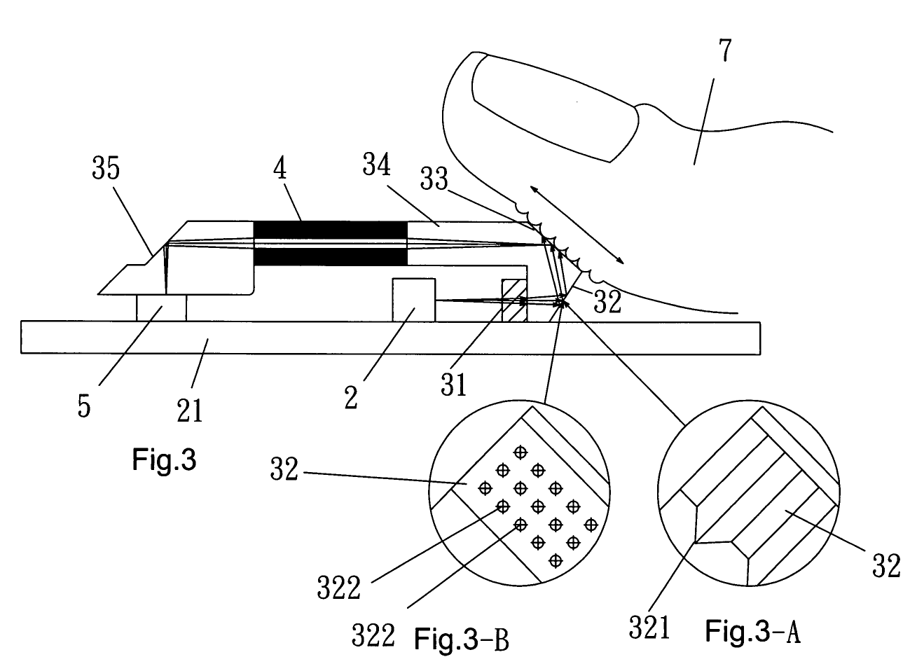

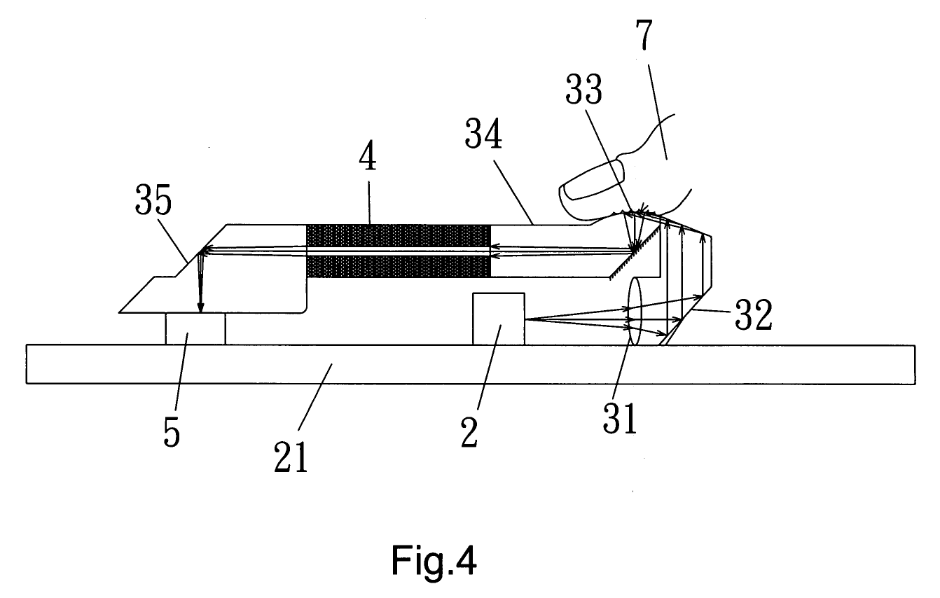

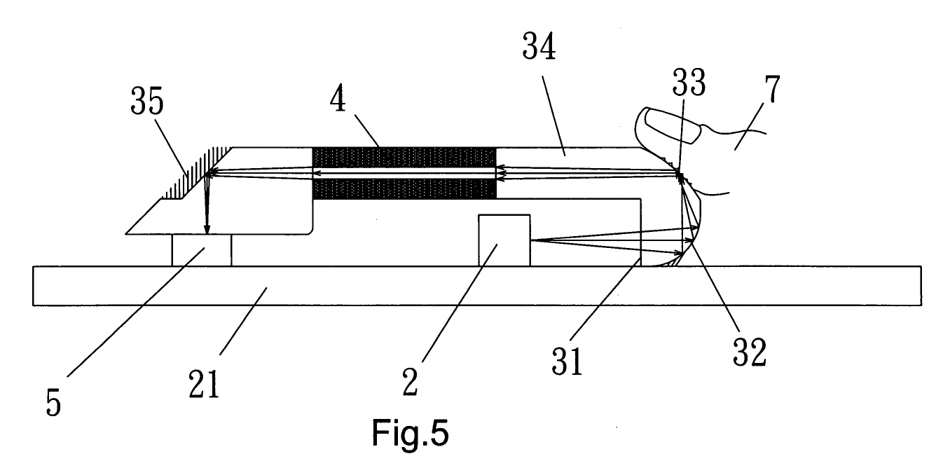

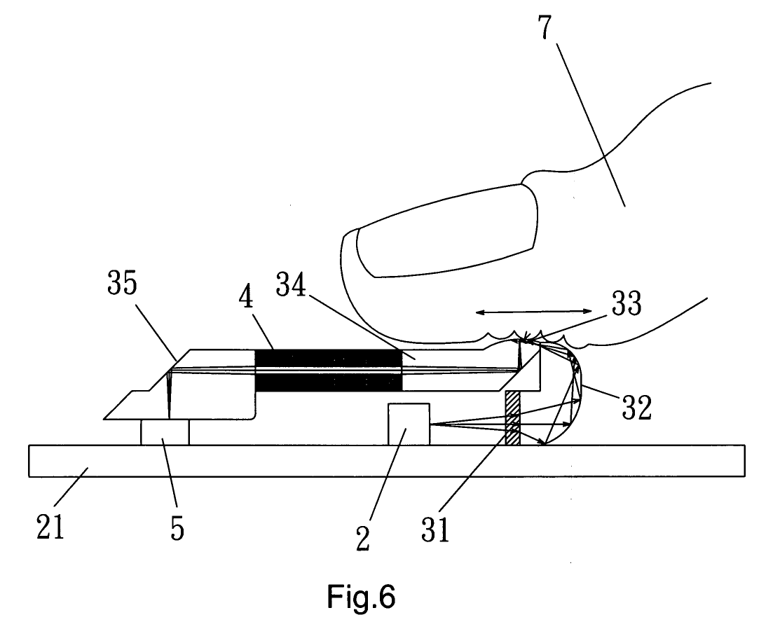

Referring to the FIG. 1, FIG. 2 and FIG. 3, FIG. 4, FIG. 5, and FIG. 6, the compact-thin contact image sensor in accordance with the present invention mainly is composed of: light sourse 2 which can be embeded in the printed circuit board 21, light pipe 3, lens 4 and strip-size imaging sensor 5. In which, the light pipe 3 is multibend, comprising an incidence panel 31, a first ray guiding interface 32, a fingerprint contact interface 33, the second ray guiding interface 34 and an image reflecting panel 35. And it can be positioned on the support base 6 to shorten the size of the image senser.

And as shown in the FIG. 3 (the first ray guiding interface 32 of the light pipe 3 makes the total internal inflection with the fingerprint contact interface 33 by means of folding surface), FIG. 4 (the first ray guiding interface 32 of another light pipe 3 makes the total internal inflection with the fingerprint contact interface 33 by means of folding surface), FIG. 5 (the first ray guiding interface 32 of the light pipe 3 makes the total internal inflection with the fingerprint contact interface 33 by means of curving surface), and FIG. 6 (the first ray guiding interface 32 of another light pipe 3 makes the total internal inflection with the fingerprint contact interface 33 by means of curving surface), all are the preferred embodiments in accordance with the present invention, in which one or more surface-mounted light emitting diodes (SM-LED) would be embedded in the printed circuit board vertically to make the light on the incidence panel 31 of the light pipe 3, and improve the fingerprint identitfication resolution and the contrast between dark-field and bright-field and reflect to the fingerprint contact interface 33 through guiding, light collecting and reflection of the first ray guiding interface 32, and keep the hand or foot 7 fingerprint section close to the fingerpring contact interface 33 and move it to make the fingerprint mound contact the strip-size fingerprint contact surface 33, accordingly, most rays would scatter to different angles to form dark-field, and because the sunk area of the fingerprint fails to contact the fingerprint contact surface 33, it would form bright-field for total internal reflection to form many strips grey-level images with a well-definite contrast in brightness, further access to a strip column lens 4 through the second ray guiding interface 34 to make the grip grey-level images into the image reflector 35 of the light pipe 3 after focusing. Lastly reflect to the strip-type sensor 5 on the printed circuit board 21, and the fingerprint image would be integrated and processed by the electronic circuit signal of the printed circuit board 21 to be a perfect one for good identification ability.

And referring to the FIG. 3-A and FIG. 3-B, in order to obtain uniform light distribution to make the ray from the LED source through guiding of the multibend light pipe 3, and to increase the marching length of the light effectively after several times of reflection to make it larger than the numberical aperture. In addition, a regular or irregular “V” groove 321 (as shown in FIG. 3-A), or, regular or irregular light scattering ball-type points 322 (as shown in FIG. 3-B) would be added to enhance the light scattering effect and effective path length while making the fingerprint contact interface 33 in the strip area can be lighted brightly and uniformly.

What is claimed is:

1. A kind of compact-thin contact image sensor is composed of: light sourse, light pipe, lens and a strip-type sensor. In which, the light pipe is multibend, comprising an incidence panel, the first ray guiding interface, a fingerprint contact interface, the second ray guiding interface and an image reflecting panel. And it can be positioned on the support base to reduce the volume of image senser.

2. The Compact-Thin Contact Image Sensor, as recited in claim 1, wherein the light source is produced from one or more surface-mounted light emitting diodes (SM-LED) and project to the incidence panel of the light pipe.

3. The Compact-Thin Contact Image Sensor, as recited in claim 1, wherein the lens in a strip column lens, which can obtain Graduated Refractive Index (GRIN).

4. The Compact-Thin Contact Image Sensor, as recited in claim 1, wherein the light pipe is made of plastic or other transparent materials.

5. The Compact-Thin Contact Image Sensor, as recited in claim 1, wherein the light pipe and lens can be positioned on a support base.

6. The Compact-Thin Contact Image Sensor, as recited in claim 1, wherein the light source and strip-type sensor can be designed on the printed circuit board.

7. The Compact-Thin Contact Image Sensor, as recited in claim 1, wherein the fingerprint contact interface designed on multibend light pipe is in the strip area to make the light can contribute and project uniformly in this area through the guiding, reflection and light collecting of the ray guiding interface.

8. The Compact-Thin Contact Image Sensor, as recited in claim 1, wherein some reflection materials can be plated on the surface of the multibend light pipe.

9. The Compact-Thin Contact Image Sensor, as recited in claim 1, wherein the first ray guiding interface of the light pipe can be formed with reflection panel by means of folding surface.

10. The Compact-Thin Contact Image Sensor, as recited in claim 1, wherein the first ray guiding interface of the light pipe also can be formed with reflection panel by means of curving surface.

11. The Compact-Thin Contact Image Sensor, as recited in claim 1, wherein the curving surface of the ray guiding interface in the light pipe can be aspherical surface.

12. The Compact-Thin Contact Image Sensor, as recited in claim 1, wherein the a regular or irregular “V” groove can be set on the surface of the first ray guiding interface of the light pipe for further scattering and uniform distribution of the light.

13. The Compact-Thin Contact Image Sensor, as recited in claim 1, wherein the first ray guiding interface of the light pipe can be designed with some regular or irregular light scattering ball-type points for uniform distribution of the light.

14. The Compact-Thin Contact Image Sensor, as recited in claim 1, wherein it is applied to mobile telephone, mobile mini disk, scanner, mouse, personal digital assistant or automobile key etc. electronic products.
